(19) United States
(12) Patent Application Publication
(10) Pub. No.: US 2023/0097631 A1
(43) Pub. Date: Mar. 30, 2023

(54) Diaphragm, MEMS Microphone Using Same, and Manufacturing Method for Same

(71) Applicant: AAC ACOUSTIC TECHNOLOGIES (SHENZHEN) CO., LTD., Shenzhen (CN)

(72) Inventors: Yuwei Liu, Singapore (SG); Rui Zhang, Shenzhen (CN); Zhenkui Meng, Shenzhen (CN)

(21) Appl. No.: 17/584,337

(22) Filed: Jan. 25, 2022

(30) Foreign Application Priority Data
Sep. 29, 2021 (CN) 202111147496.1

(51) Int. Cl. H04R 19/04; H04R 7/02

(52) U.S. Cl. CPC H04R 19/04; H04R 7/02; H04R 2201/003

(57) ABSTRACT

The invention provides a diaphragm and a preparation method thereof, and an MEMS microphone. The diaphragm includes a intermediate vibration part and a fixed part surrounding the vibration part. The vibration part includes multiple vibration sub-parts, which are distributed stepwise along the vibration direction of the diaphragm. Multiple vibration sub-parts are distributed stepwise along the vibration direction of diaphragm. The effective area of the diaphragm is increased, and the stress can be adjusted by the height of the ladder and its inclination angle. The mechanical sensitivity of the MEMS microphone containing this diaphragm is improved, resulting in a high-performance, small-sized MEMS microphone.

### FIELD OF THE PRESENT DISCLOSURE

The present invention relates to electromechanical transducers, and more particularly to a diaphragm of a MEMS microphone.

### DESCRIPTION OF RELATED ART

In recent years, mobile communication technology has been rapidly developed, and consumers are increasingly using mobile communication devices, among which the microphone is one of the important components. With the development of society and the continuous advancement of high-tech technology, micro-electro-mechanical systems (MEMS) has gradually been integrated into the production field of microphones. MEMS has achieved miniaturization and low cost of various sensors, and signal conversion devices such as MEMS silicon microphones have appeared in smart terminals.

The requirements of the microphone are high performance and small size, and these two points obviously restrict each other. The packaging size limit directly affects the size of the MEMS microphone.

In view of the above-mentioned problems, it is necessary to propose a diaphragm, a preparation method thereof, and an MEMS microphone that is reasonably designed and can effectively improve the above-mentioned problems.

### SUMMARY OF THE PRESENT INVENTION

One of the main objects of the present invention is to provide a MEMS microphone with improved diaphragm.

To achieve the above-mentioned objects, the present invention provides a diaphragm, including: a vibration part in a middle, having a plurality of vibration sub-parts; and a fixed part surrounding the vibration part. The plurality of vibration sub-parts are distributed stepwise along a vibration direction of the diaphragm.

In addition, a center of each of the vibration sub-parts coincides with centers of the remaining vibration sub-parts; or,

a center of at least one of the vibration sub-parts does not coincide with the centers of the remaining vibration sub-parts.

In addition, the vibration sub-part includes a sidewall and a top wall connected to the sidewall; the sidewall is perpendicular to the top wall; or, a preset inclination angle is formed between the sidewall and the top wall.

In addition, the fixed part includes a first fixed wall and a second fixed wall bending and extending from an inner end of the first fixed wall in a direction away from the vibration part.

The invention further provides a method for preparing a diaphragm including steps of:

providing a substrate;

forming a multilayer sacrificial layers on the isolation layer;

patterning the multilayer sacrificial layer such a that an edge area of the multilayer sacrificial layer is distributed stepwise;

forming a diaphragm on the surface of the isolation layer and the patterned multilayer sacrificial layer.

In addition, the step of forming a diaphragm on the surface of the isolation layer and the patterned multilayer sacrificial layer includes:

patterning the isolation layer to form a through hole at the edge of the bottom sacrificial layer corresponding to the graphics of the isolation layer;

forming the diaphragm on the surface of the isolation layer and the patterned multilayer sacrificial layer and in the through hole.

The invention further provides a MEMS microphone, including: a base with a back cavity; a capacitance system disposed the base and insulated from the base, including a diaphragm as described above, and a back plate forming a distance from the diaphragm; at least one through hole in the back plate; and a back plate electrode provided on a side of the back plate facing the diaphragm.

In addition, the diaphragm includes a fixed part having a first fixed wall sandwiched between the base and the back plate and a second fixed wall with an end abutting against the base.

In addition, the back plate further includes at least one protruding part protruding toward the diaphragm from the back plate electrode.

In addition, the protruding part corresponds to a position of the vibration sub-part closest to the back plate.

### BRIEF DESCRIPTION OF THE DRAWINGS

Many aspects of the exemplary embodiments can be better understood with reference to the following drawings. The components in the drawing are not necessarily drawn to scale, the emphasis instead being placed upon clearly illustrating the principles of the present disclosure.

FIG. 1 is a cross-sectional view of a diaphragm in accordance with an exemplary embodiment of the present invention;

FIG. 2 is a flow chart of a method for preparing the diaphragm;

FIGS. 3-8 are cross-sectional views of the preparation process of a diaphragm of the present invention;

FIG. 9 is a cross-sectional view of an MEMS microphone using the diaphragm.

### DETAILED DESCRIPTION OF THE EXEMPLARY EMBODIMENTS

The present disclosure will hereinafter be described in detail with reference to several exemplary embodiments. To make the technical problems to be solved, technical solutions and beneficial effects of the present disclosure more apparent, the present disclosure is described in further detail together with the figures and the embodiments. It should be understood the specific embodiments described hereby are only to explain the disclosure, not intended to limit the disclosure.

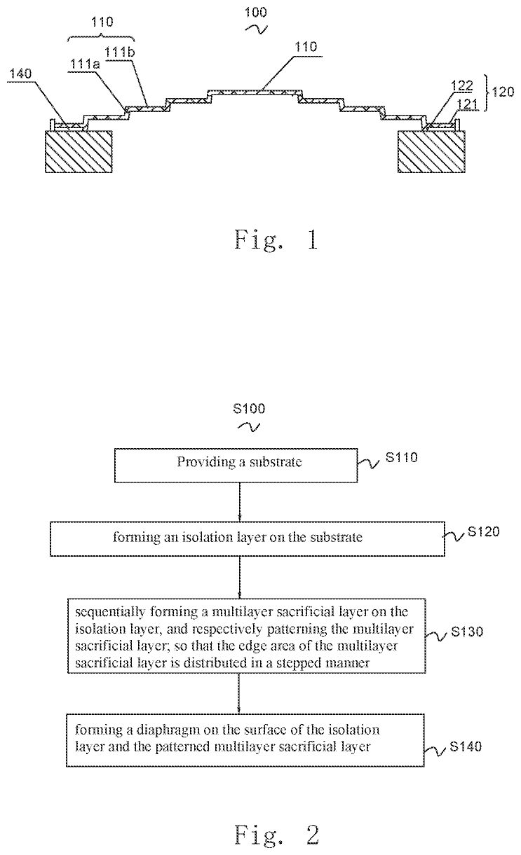

As shown in FIG. 1, the present invention provides a diaphragm 100 which includes a vibration part 110 in the middle and a fixed part 120 surrounding the vibration part 110. The vibration part 110 includes multiple vibration sub-parts 111. The multiple vibration sub-parts 111 are distributed stepwise along the vibration direction of the diaphragm 100. In other words, the vertical section of the vibration part 110 of the diaphragm 100 is stepped.

The diaphragm of the embodiment of the present invention, the diaphragm includes an intermediate vibration part and a fixed part surrounding the vibration part. The vibration part includes multiple vibration sub-parts. Multiple vibration sub-parts are distributed stepwise along the vibration direction of the diaphragm, which increases the effective area of the diaphragm. The stress can be adjusted by the height of the steps and their inclination angle. The mechanical sensitivity of the MEMS microphone containing this diaphragm is improved, resulting in a high-performance, small-sized MEMS microphone.

Exemplarily, as shown in FIG. 1, the center of each vibration sub-part 111 coincides with the centers of other vibration sub-parts 111. In other words, the vibration part 110 of the diaphragm 100 has a stepped shape of concentric circles. Or, the center of at least one vibration sub-part 111 does not coincide with the centers of the remaining vibration sub-parts 111. In other words, it is possible that the centers of one vibration sub-part 111 and the rest of the vibration sub-parts 111 do not overlap, or the centers of each vibration sub-part 111 do not overlap. The vibration part 110 of the diaphragm 100 has a stepped shape of non-concentric circles.

Exemplarily, as shown in FIG. 1, the vibration sub-part 111 includes a sidewall 111a, and a top wall 111b connected to the sidewall 111a. Wherein, the sidewall 111a is perpendicular to the top wall 111b. Alternatively, a preset inclination angle is arranged between the sidewall 111a and the top wall 111b, and the inclination angle may be an acute angle or an obtuse angle. In this embodiment, the inclination angle between the sidewall 111a and the top wall 111b is an acute angle. The stress can be adjusted by the height of the top wall and the preset inclination angle between the sidewall and the top wall.

Exemplarily, as shown in FIG. 1, the fixed part 120 includes a first fixed wall 121, and a second fixed wall 122 bending and extending from the inner end of the first fixed wall 121 in a direction away from the vibration part 110.

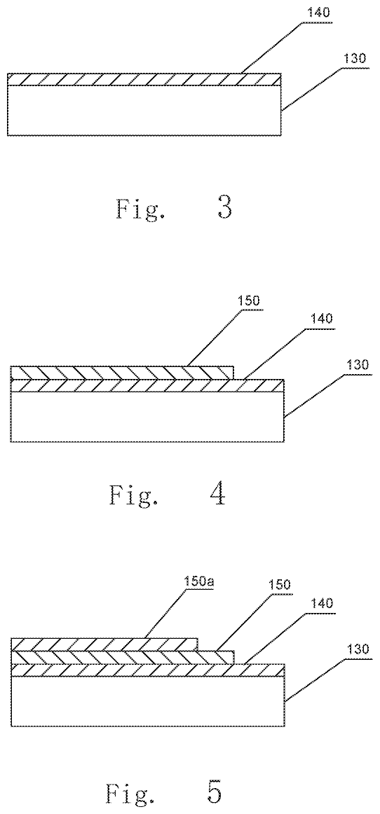

As shown in FIG. 2, another aspect of the present invention provides a preparation method s100 of diaphragm, which includes:

s110, provide substrate.

Specifically, the material of the substrate 130 may be silicon, or germanium, silicon germanium, or gallium arsenide. The embodiment is not specifically limited, and those skilled in the art can choose according to their needs.

s120, forming an isolation layer on the substrate.

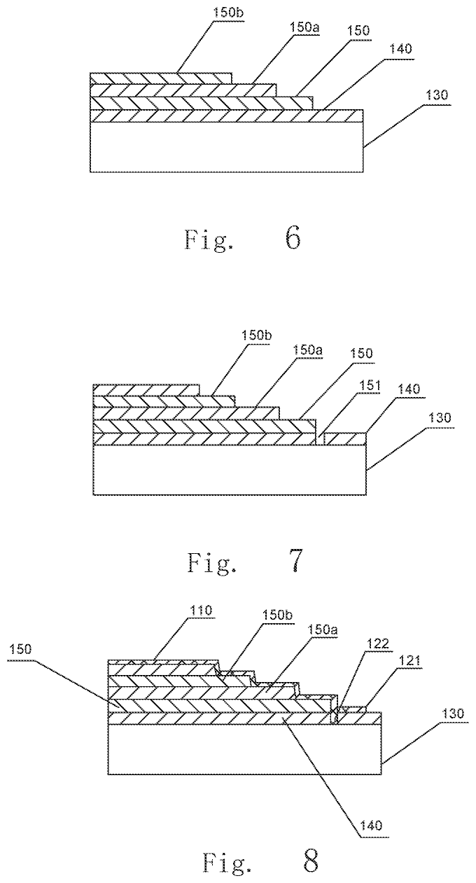

Specifically, as shown in FIG. 3, an isolation layer 140 is deposited on the substrate 130, and the isolation layer 140 may be an oxide isolation layer. For example, silicon oxide, etc., or other materials known to those skilled in the art.

s130, sequentially forming a multilayer sacrificial layer on the isolation layer, and respectively patterning the multilayer sacrificial layer; so that the edge area of the multilayer sacrificial layer is distributed in a stepped manner.

Specifically, as shown in FIG. 4, a bottom sacrificial layer 150 is deposited on the isolation layer 140, and a photoresist is formed on the bottom sacrificial layer 150. Using a photolithography process, the photoresist is exposed and developed to form a patterned photoresist layer. The positions where the grooves are to be formed on the sacrificial layer 150 are exposed. The bottom sacrificial layer 150 is etched using the patterned photoresist layer as a mask. Furthermore, the edge portion of the bottom sacrificial layer 150 is graphically displayed, so that the orthographic projection of the graphical bottom sacrificial layer 150 on the isolation layer 140 is on the inner side of the isolation layer 140.

As shown in FIG. 5, a first sacrificial layer 150a is deposited on the bottom sacrificial layer 150. The edge portion of the first sacrificial layer 150a is patterned by photolithography and etching processes. In this way, the orthographic projection of the graphical first sacrificial layer 150a on the underlying sacrificial layer 150 is on the inner side of the underlying sacrificial layer 150.

As shown in FIG. 6, a second sacrificial layer 150 is deposited on the first sacrificial layer 150a. The edge portion of the second sacrificial layer 150b is patterned by photolithography and etching processes. In this way, the orthographic projection of the graphical second sacrificial layer 150b on the first sacrificial layer 150a is inside the first sacrificial layer 150a.

As shown in FIG. 7 and by analogy, using the same process, the remaining layers of the sacrificial layer 150 are sequentially deposited on the second sacrificial layer 150b. Graphicalize each layer of sacrificial layer 150a. In this way, the orthographic projection of the upper sacrificial layer 150 of every two adjacent sacrificial layers 150 on the lower sacrificial layer 150 is located inside the lower sacrificial layer 150. In this way, the edge area of the multilayer sacrificial layer 150 is distributed stepwise.

In this embodiment, the sacrificial layer 150 may be an oxide sacrificial layer, such as silicon dioxide. Those skilled in the art can choose according to their needs.

s140, forming a diaphragm on the surface of the isolation layer and the patterned multilayer sacrificial layer.

First, the isolation layer is patterned to form a through hole at the edge of the patterned sacrificial layer corresponding to the isolation layer.

As shown in FIG. 7, the isolation layer 140 is patterned using photolithography and etching processes. A 151 through hole is formed at the edge of the isolation layer 140 corresponding to the patterned bottom sacrificial layer 150. The through hole 151 exposes the isolation layer 140, and the through hole 151 may be one, two, three or more. This embodiment does not make specific restrictions.

Secondly, the diaphragm is formed on the surface of the isolation layer and the patterned multilayer sacrificial layer and in the through hole.

As shown in FIG. 8, a diaphragm material layer is deposited on the surface of the isolation layer 140 and the patterned multilayer sacrificial layer 150. The isolation layer 140 and the patterned multilayer sacrificial layer 150 are etched and removed by an etching process. The diaphragm 100 is formed. The diaphragm material layer fills the through hole 151 to form an anchor point, which is the second fixed wall 122 described in FIG. 1. The anchor point is also part of the diaphragm 100, which plays a fixed role in the diaphragm 100. The anchor points correspond to the through hole 151 and can be one, two, three or more. The etching process may be dry etching, for example, oxygen plasma is used to dry etching the isolation layer 140 and the multilayer sacrificial layer 150. It may also be wet etching, for example, a buffered oxide etching method is used, and the structure formed in the previous step is placed in an oxide etching solution. The isolation layer 140 and the multilayer sacrificial layer 150 are etched.

The material of the diaphragm 100 can be polysilicon, silicon germanium, germanium, or other elastic metal or semiconductor materials. Make sure that the diaphragm can be restored to its original shape after being deformed by vibration due to sound or inertial force. And to ensure that the diaphragm has good conductivity. In this embodiment, the diaphragm material chooses polysilicon material.

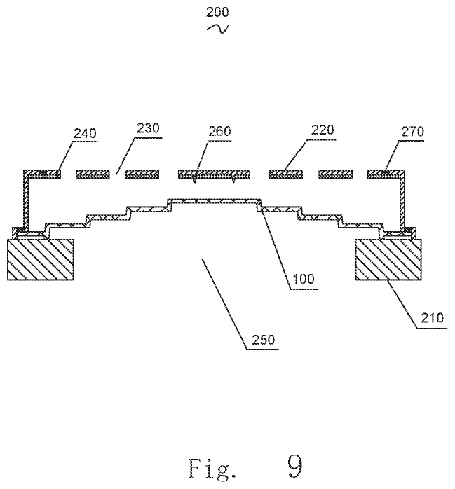

As shown in FIG. 9, another aspect of the present invention provides an MEMS microphone 200, which includes a base 210 with a back cavity 250, and a capacitance system arranged on the base 210 and insulated from the base 210. The capacitance system includes a diaphragm 100 and a back plate 220 set apart from the diaphragm 100. At least one through hole 230 is provided on the back plate 220. A back plate electrode 240 is provided on the side of the back plate 220 facing the diaphragm 100. The diaphragm 100 uses the diaphragm 100 described above. Wherein, diaphragm 100 is insulated from base 210 through isolation layer 140. The diaphragm 100 can be insulated from the base 210 via an isolation layer 140. In other alternative embodiments, the diaphragm 100 is in high-resistance communication with the base 210 through a fixed part 122. The specific structure of the diaphragm 100 has been described in detail above, and will not be repeated here. The MEMS microphone 200 is electrically connected to the corresponding device through a metal connection wire 270 arranged on the back plate 220.

It should be noted that in this embodiment, the material of the back plate 220 may be nitride, such as silicon nitride. The material of the back plate electrode 240 may be a polysilicon material. The material of base 210 may be silicon.

Multiple vibration sub-parts of diaphragm in MEMS microphone are distributed stepwise along the vibration direction of diaphragm, increasing the effective area of diaphragm. The stress can be adjusted by the height of the ladder and its inclination angle, which improves the mechanical sensitivity of the MEMS microphone. In order to obtain a high-performance, small-sized MEMS microphone.

Exemplarily, as shown in FIGS. 1 and 9, when the fixed part 120 of the diaphragm 100 includes a first fixed wall 121 and a second fixed wall 122. The first fixed wall 121 is sandwiched between the base 210 and the back plate 220. The end of the second fixed wall 122 abuts against the base 210. The first fixed wall 121 fixes the diaphragm 100 on the back plate 220. The second fixed wall 122 fixes the diaphragm 100 to the base 210.

Exemplarily, as shown in FIG. 9, the back plate 220 is further provided with at least one protruding part 260 protruding toward the diaphragm 100 direction. The protruding part 260 protrudes from the back plate electrode 240. The protruding part can prevent the back plate from sticking to the diaphragm. The protruding part 260 can be one, two, three or more, and the shape can be cylindrical, inverted drop shape, etc. The embodiment does not specifically limit the number and shape of protruding parts. As long as it can prevent the back plate from sticking to the diaphragm.

Exemplarily, the protruding part 260 corresponds to the position of the vibration sub-part 111 closest to the back plate 220. In other words, the vibration sub-part 111 is distributed stepwise along the vibration direction of the diaphragm 100. Therefore, the protruding part 260 can be installed only at the position where the distance between the back plate 220 and the diaphragm 100 is the narrowest. There is no need to install protruding part 260 at all positions of the back plate 220, which can save costs. In this embodiment, as shown in FIG. 9, the longitudinal section of the diaphragm 100 is stepped toward the back plate 220. Therefore, only the protruding part 260 is arranged in the central area of the back plate 220.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A diaphragm, including:
a vibration part in a middle, having a plurality of vibration sub-parts;
a fixed part surrounding the vibration part; wherein
the plurality of vibration sub-parts are distributed stepwise along a vibration direction of the diaphragm.

2. The diaphragm as described in claim 1, wherein a center of each of the vibration sub-parts coincides with centers of the remaining vibration sub-parts; or,
a center of at least one of the vibration sub-parts does not coincide with the centers of the remaining vibration sub-parts.

3. The diaphragm as described in claim 1, wherein, the vibration sub-part includes a sidewall and a top wall connected to the sidewall; the sidewall is perpendicular to the top wall; or, a preset inclination angle is formed between the sidewall and the top wall.

4. The diaphragm as described in claim 1, wherein, the fixed part includes a first fixed wall and a second fixed wall bending and extending from an inner end of the first fixed wall in a direction away from the vibration part.

5. A method for preparing a diaphragm including steps of:
providing a substrate;
forming a multilayer sacrificial layers on the isolation layer;
patterning the multilayer sacrificial layer such that an edge area of the multilayer sacrificial layer is distributed stepwise;
forming a diaphragm on the surface of the isolation layer and the patterned multilayer sacrificial layer.

6. The method as described in claim 5, wherein, the step of forming a diaphragm on the surface of the isolation layer and the patterned multilayer sacrificial layer includes:
patterning the isolation layer to form a through hole at the edge of the bottom sacrificial layer corresponding to the graphics of the isolation layer;
forming the diaphragm on the surface of the isolation layer and the patterned multilayer sacrificial layer and in the through hole.

7. A MEMS microphone, including:
a base with a back cavity;
a capacitance system disposed on the base and insulated from the base, including a diaphragm as described in claim 1, and a back plate forming a distance from the diaphragm;
at least one through hole in the back plate;
a back plate electrode provided on a side of the back plate facing the diaphragm.

8. The MEMS microphone as described in claim 7, wherein, the diaphragm includes a fixed part having a first fixed wall sandwiched between the base and the back plate and a second fixed wall with an end abutting against the base.

9. The MEMS microphone as described in claim 7, wherein, the back plate further includes at least one protruding part protruding toward the diaphragm from the back plate electrode.

10. The MEMS microphone as described in claim 9, wherein, the protruding part corresponds to a position of the vibration sub-part closest to the back plate.
